(19) United States
(12) Patent Application Publication
(10) Pub. No.: US 2024/0168745 A1
(43) Pub. Date: May 23, 2024

(54) METHOD FOR BUILDING AND DEPLOYING INFORMATION LEAKAGE PREVENTION APPLICATION BASED ON CONTAINER

(71) Applicant: SOMANSA CO., LTD., Seoul (KR)

(72) Inventors: Tae Wan KIM, Seoul (KR); Soo Min HWANG, Seoul (KR)

(73) Assignee: SOMANSA CO., LTD., Seoul (KR)

(21) Appl. No.: 18/511,813

(22) Filed: Nov. 16, 2023

(30) Foreign Application Priority Data
Nov. 21, 2022 (KR) 10-2022-0156321

(51) Int. Cl. G06F 8/61; G06F 9/445

(52) U.S. Cl. CPC G06F 8/63; G06F 9/44505

(57) ABSTRACT

According to the present invention, a method for building and deploying an information leakage prevention application based on a container may include the steps of: under a container environment, installing and configuring packages of an application for information leakage prevention under an application installation directory and building an image according to the creation of a deployment image for the application; and deploying the application using the deployment image generated according to image building.

### CROSS-REFERENCE TO RELATED APPLICATION(S)

This application claims the benefit under 35 USC § 119(a) of Korean Patent Application No. 10-2022-0156321, filed on Nov. 21, 2022, in the Korean Intellectual Property Office, the entire disclosure of which is incorporated herein by reference for all purposes.

### BACKGROUND

### 1. Field

The present invention relates to a method for efficiently building and deploying an existing on-premise information leakage prevention application on a new container environment.

### 2. Description of Related Art

Information leakage prevention applications provide the functionality to inspect and control data that users store or transmit according to policies, store and retrieve resulting incidents, and query and report the incidents. An information leakage prevention application consists of a user data inspection and control module, a policy management module, an incident storage module, an incident retrieval module, an incident management module, a database module that stores policies and incidents, and a search engine module. Each module of the information leakage prevention application loads configuration files for execution, loads or stores data files for policy and incident data processing, and stores events that occur during execution in a log file.

To migrate an on-premises information leakage prevention application which is distributed by installing and configuring modules of the application on a server to a container environment such as Docker or Kubernetes, it is necessary to use container volumes to persistently store configuration files, data files, and log files of each module externally, even if the container is stopped or deleted, irrespective of the container's life cycle. If container volumes are created and mounted for use for each module of the container-based information leakage prevention application, such as configuration files or directories, data files or directories, or log files or directories, it may lead to the creation of numerous container volumes, making container volume management difficult. In addition, when deploying and running a container after building an image by moving configuration files or directories, or data files or directories, of each module to a separate directory, a method of copying the moved configuration files or directories, or the moved data files or directories, back to their original paths may be used. In this case, it may be difficult to manage if there are numerous items to move and copy. Therefore, for the purpose of building and deploying the container-based information leakage prevention application, an efficient method is needed that uses a single container volume to store configuration files, data files, and log files of each module of the information leakage prevention application.

[Prior Art Document Korean Laid-open Patent Publication No. 10-2014-0018329]

### SUMMARY

An object of the present invention is to provide a method for building and deploying a container-based information leakage prevention application in a container environment, enabling efficient management of configuration files, data files, and log files of multiple modules as a container volume, which is a single persistent storage.

According to the present invention to achieve the above object, a method for building and deploying an information leakage prevention application based on a container includes the steps of: based on a container environment, installing and configuring packages of an application for information leakage prevention under an application installation directory and building an image according to the creation of a deployment image for the application; and deploying the application using the deployment image generated according to image building.

The building of the image may include creating a package image for the application; installing and configuring at least one of configuration files, data files, or log files constituting the packages in a sub-path of an application installation directory; and creating the deployment image for the application by committing changes in a container due to installation and configuration of the packages.

The installing and configuring of the packages under the application installation directory may include determining whether a detailed module is a path-settable detailed module that can set paths for the packages; and, if the detailed module is a path-settable detailed module, installing and configuring a configuration file, data file, or log file of the path-settable detailed module in a sub-path of the application installation directory.

The installing and configuring of the packages under the application installation directory may include, if the detailed module is a path-non-settable detailed module that cannot set paths for the packages, installing and configuring a configuration file, data file, or log file of the path-non-settable detailed module in a default set path; moving a configuration file, data file, or log file for the path-non-settable detailed module to a sub-path of the application installation directory; and creating a symbolic link in the default set path to refer to the configuration file, data file, or log file for the path-non-settable detailed module.

The deploying of the application may include defining a container volume to be overlay-mounted to the application installation directory and deploying the application by executing a container.

An application installation directory of a container file system according to the deployment of the application may include a directory structure where an application installation directory of a deployment image file system, which is a read-only lower layer, and an application installation directory of a container volume, which is a writable upper layer, are merged.

In the application installation directory of the container file system, when changes are made to configuration files, data files, and log files in a container, configuration files, data files, and log files of the application installation directory of the deployment image file system may be copied to the application installation directory of the container volume, and configuration files, data files, and log files of the application installation directory of the container volume may be modified.

### BRIEF DESCRIPTION OF THE DRAWINGS

FIG. 1 is a flowchart illustrating a method for building and deploying an information leakage prevention application based on a container according to the present invention.

FIG. 2 is a flowchart illustrating one embodiment to describe an image building step for an application in the method shown in FIG. 1.

FIG. 3 is a reference diagram illustrating an application deployment image created in the image building step for an application.

FIG. 4 is a flowchart illustrating one embodiment to describe the step of installing and configuring packages shown in FIG. 2 in a sub-path of an application installation directory.

FIG. 5 is a reference diagram illustrating a directory structure of a file system for an information leakage prevention application in an on-premise environment.

FIG. 6 is a reference diagram illustrating a directory structure of a deployment image file system for an information leakage prevention application in a container environment.

FIG. 7 is a reference diagram illustrating the configuration of application container and application volume according to the deployment of a container-based information leakage prevention application.

FIG. 8 is a reference diagram illustrating a directory structure of a container volume corresponding to the directory structure of the deployment image file system of FIG. 6.

FIG. 9 is a reference diagram illustrating a directory structure of an overlay-mounted container file system in which the deployment image file system of FIG. 6 and the container volume of FIG. 8 are merged.

FIG. 10 is a flowchart illustrating a file access process for detailed modules of an application when a container-based information leakage prevention application is deployed and executed.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Embodiments of the disclosure will be described hereinafter with reference to the accompanying drawings.

Reference will now be made in detail to example embodiments, examples of which are illustrated in the accompanying drawings. However, the present disclosure is not limited to the embodiments described hereinafter. Rather, these embodiments are provided so that this disclosure will be thorough and complete, and will fully convey the concept of the invention to one of ordinary skill in the art.

The terms used herein are to explain exemplary embodiments and are not intended to limit the present invention. As used herein, singular forms, unless contextually defined otherwise, may include plural forms. Also, the terms “comprise” and/or “comprising” are used herein to specify the present of stated shapes, numbers, operations, members, elements, and/or groups thereof but do not preclude the presence or addition of one or more other shapes, numbers, operations, members, elements and/or groups thereof. As used herein, the term “and/or” includes any and all combinations or one of a plurality of associated listed items.

In the present invention, a method of efficiently building and deploying a container-based information leakage prevent application comprises the steps of building an image of a container-based information leakage prevention application and deploying a container.

In the step of building an image of a container-based information leakage prevention application, an information leakage prevention application package image is created in a container environment by copying packages for each module, the packages for each module are installed and configured to place configuration files, data files, and log files under a single information leakage prevention application installation directory, and changes in a container due to module installation and configuration are committed to create an information leakage prevention application deployment image.

In the step of deploying a container of the container-based information leakage prevention application, a container volume where the deployment image created in the image building step and the configuration files, data files, and log files mounted and changed in the container are stored, and a container manifest to overlay-mount the container volume to the application installation directory by merging the mounted container volume with the application installation directory when executing a container are defined and the application is deployed by executing the container.

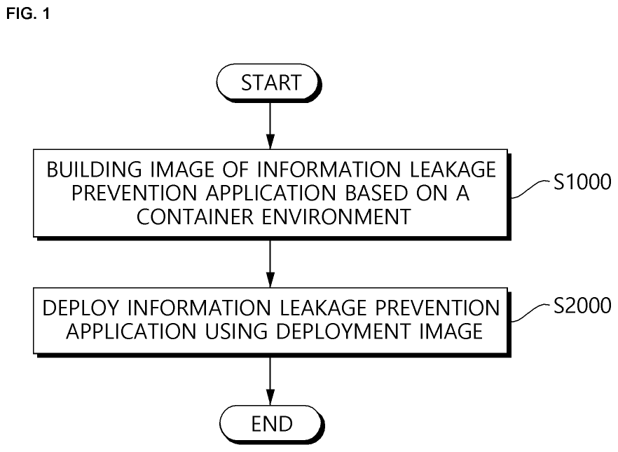

FIG. 1 is a flowchart illustrating a method for building and deploying an information leakage prevention application based on a container according to the present invention. For this purpose, a building and deployment system for a container-based information leakage prevention application may include an application building unit and an application deployment unit. These application building and deployment units may be comprised of processors and storage media.

First, the application building unit, based on a container environment, installs and configures packages for the information leakage prevention application under an application installation directory and then builds an image according to the creation of a deployment image for the application (Step S1000).

In the step of building an image of a container-based information leakage prevention application, an information leakage prevention application package image is generated in a container environment by copying packages for each module, the packages for each module are installed and configured to place configuration files, data files, and log files under a single information leakage prevention application installation directory, and changes in a container due to module installation and configuration are committed to create an information leakage prevention application deployment image.

For modules that can set paths for configuration files or directories, data files or directories, and log files or directories in order to place the configuration files, data files, and log files under a single information leakage prevention application installation directory, the module packages are installed and configured by specifying the files or directory paths as sub-paths of the information leakage prevention application installation directory. On the other hand, for modules that cannot set paths for configuration files or directories, data files or directories, and log files or directories, the module packages are installed and configured first. Then, the files and directories are moved to sub-paths under the information leakage prevention application installation directory, and symbolic links (soft links) referencing the moved paths are created on the paths of the files and directories.

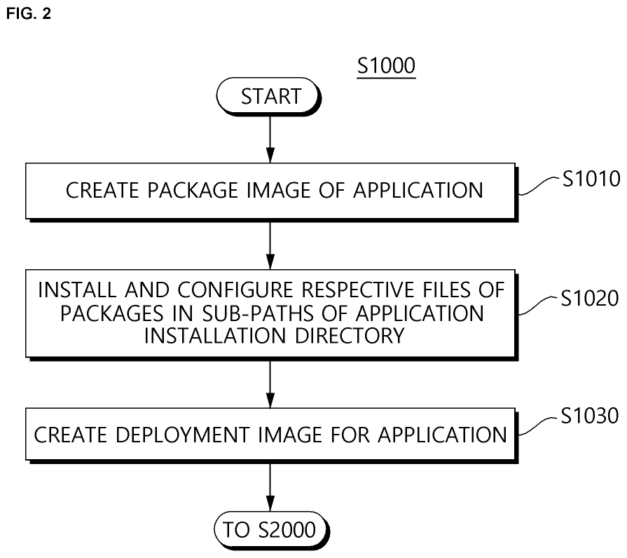

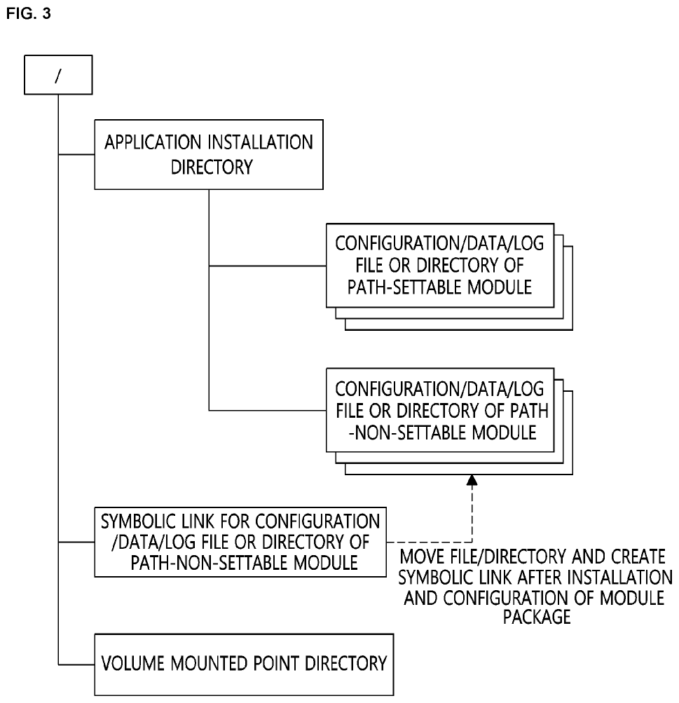

FIG. 2 is a flowchart illustrating one embodiment to describe the step S1000 of building an image of the application in the method shown in FIG. 1. FIG. 3 is a reference diagram illustrating an application deployment image created in the application image building step of FIG. 2.

The application building unit creates a package image for the application (Step S1010). The application building unit creates a package image by copying each of the individual packages for detailed modules constituting the application (Step S1010).

Following Step S1010, the application building unit installs and configures at least one of the configuration files, data files, or log files, constituting the packages, included in the package image in a sub-path of the application installation directory in the container environment (Step S1020).

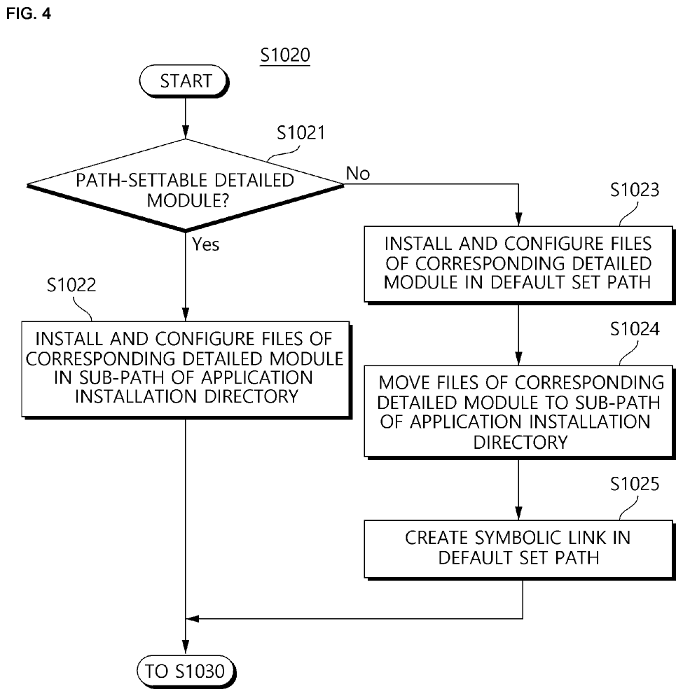

FIG. 4 is a flowchart illustrating one embodiment to describe the step S1020 of installing and configuring the packages shown in FIG. 2 in a sub-path of the application installation directory.

The application building unit determines whether the detailed modules of the information leakage prevention application are path-settable detailed modules that can set paths for the packages (step S1021).

If, at step S1021, it is determined that the detailed modules are path-settable detailed modules capable of setting paths for the package, the application building unit installs and configures the configuration files, data files, or log files of these path-settable detailed modules in a sub-path of the application installation directory (step S1022). Referring to the deployment image of FIG. 3, it illustrates that the configuration files, data files, or log files of path-settable detailed modules are installed and configured in a sub-path of the application installation directory.

However, at step S1021, if it is determined that the detailed modules are path-non-settable detailed modules that cannot set paths for the package, the application building unit installs and configures the configuration files, data files, or log files of the path-non-settable detailed modules in a default set path (Step S1023).

After step S1023, the application building unit moves the configuration files, data files, or log files of the path-non-settable detailed modules to a sub-path of the application installation directory (Step S1024). Referring to the deployment image of FIG. 3, it illustrates that the configuration files, data files, or log files of the path-non-settable detailed modules are initially installed and configured in the default set path and then moved to a sub-path of the application installation directory.

Following step S1024, the application building unit creates symbolic links in the default set path, allowing access to the configuration files, data files, or log files of the path-non-settable detailed modules (Step S1025). Referring to the deployment image of FIG. 3, it illustrates that after the configuration files, data files, or log files of the path-non-settable detailed modules have been moved to a sub-path of the application installation directory, symbolic links have been created in the default set path to refer to each of the path-non-settable detailed module's files.

After step S1020 described above, the application building unit commits container changes in a container resulting from the installation and configuration of packages to create a deployment image for the application (Step S1030). As shown in FIG. 3, in the application deployment image created according to the building of the image of the application, the configuration files, data files, and log files are positioned on one sub-path of the information leakage prevention application installation directory.

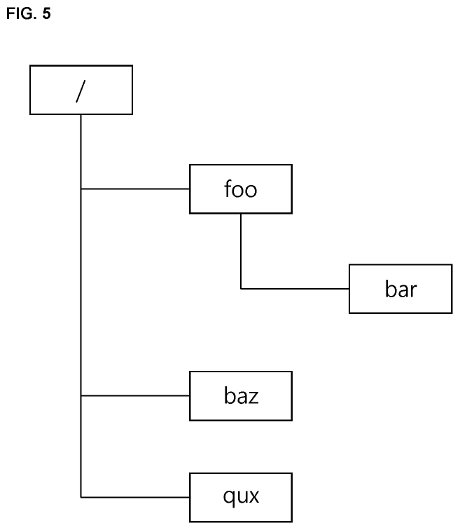

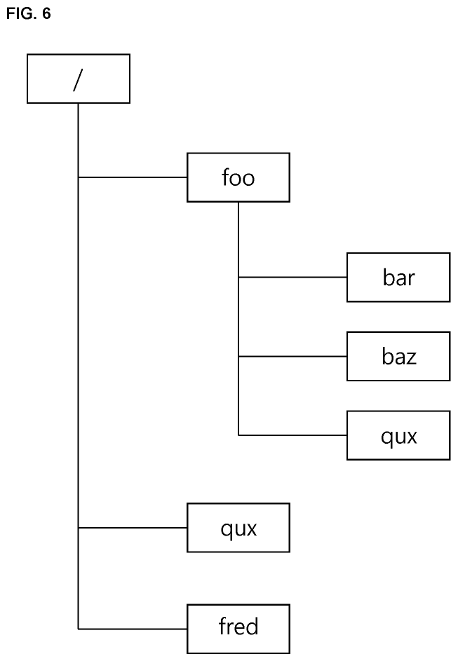

FIGS. 5 and 6 are reference diagrams to compare deployment images resulting from the image build of the information leakage prevention application. FIG. 5 is a reference diagram illustrating the directory structure of a file system for an on-premises information leakage prevention application, and FIG. 6 is a reference diagram illustrating the directory structure of a deployment image file system for an information leakage prevention application in a container environment.

Referring to FIG. 5, the directory structure of the configuration file, data file, and log file of the on-premises information leak prevention application file system is as follows.
/foo: Application installation directory,
/foo/bar: Configuration file, data file, or log file directory of a bar module,
/baz: Configuration file, data file, or log file directory of a baz module (path can be set)
/qux: Configuration file, data file, or log file directory of a qux module (path cannot be set).

On the other hand, referring to FIG. 6, the detailed structure of the directory in the deployment image file system for the container-based information leakage prevention application is as follows:
/foo: Application installation directory,
/foo/bar: Configuration file, data file, and log file directory of the bar module (no changes),
/foo/baz: Configuration file, data file, or log file directory of the baz module (path is set and changed from the original/baz),
/foo/qux: Configuration file, data file, or log file directory of the qux module (directories and files are moved from the original/qux directory),
/qux: Symbolic link referencing/foo/qux (newly created),
/fred: Directory where volumes are to be mounted in the container (newly created).

Meanwhile, following step S1000, the application deployment unit deploys the above application using the deployment image created according to the image build (Step S2000). Configuration files, data files, and log files that are mounted and changed in the container are stored in the container volume.

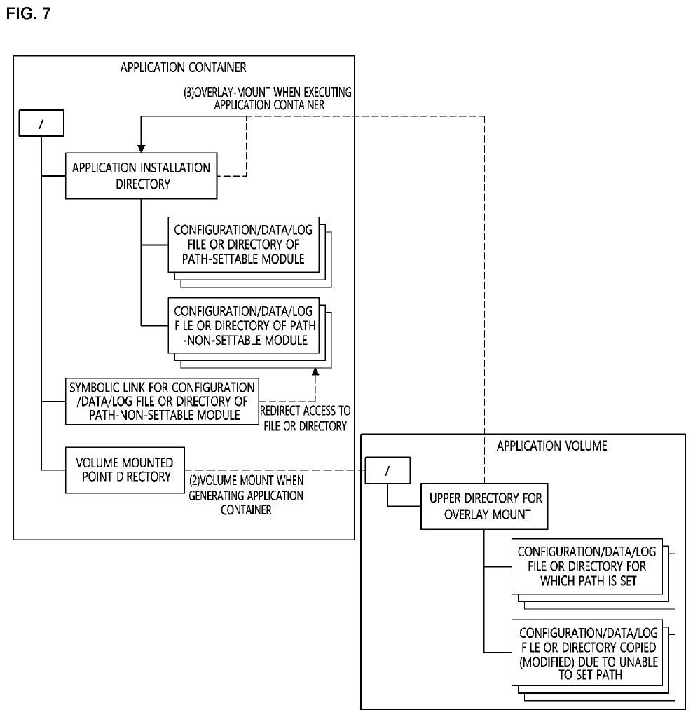

FIG. 7 is a reference diagram illustrating the configuration of application container and application volume according to the deployment of a container-based information leakage prevention application.

The application deployment unit defines the container volume to be overlay-mounted to the aforementioned application installation directory, and deploys the application by executing the container. The application deployment unit defines a container manifest to overlay-mount the container volume to the application installation directory by merging the mounted container volume with the application installation directory when executing the container.

In this case, the application installation directory of the container file system, resulting from the deployment of the application, includes a directory structure where the application installation directory of the deployment image file system, which is a read-only lower layer, is merged with the application installation directory of the container volume, which is a writable upper layer.

In the application installation directory of the container file system, when changes are made to the configuration files, data files, and log files in the container, the configuration files, data files, and log files of the application installation directory of the deployment image file system may be copied to the application installation directory of the container volume, and the configuration files, data files, and log files of the application installation directory of the container volume may be modified.

In other words, the overlay-mounted application installation directory of the container file system works as a copy-on-write (COW) mechanism, so that the configuration files, data files, and log files of the application installation directory in the deployment image file system are copied to the volume's application installation directory and the configuration files, data files, and log files of the volume's application installation directory are modified.

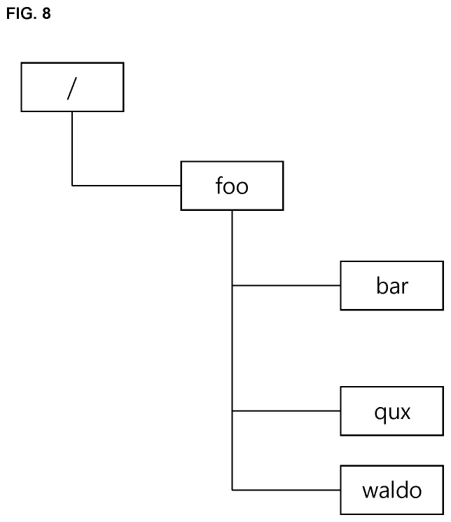

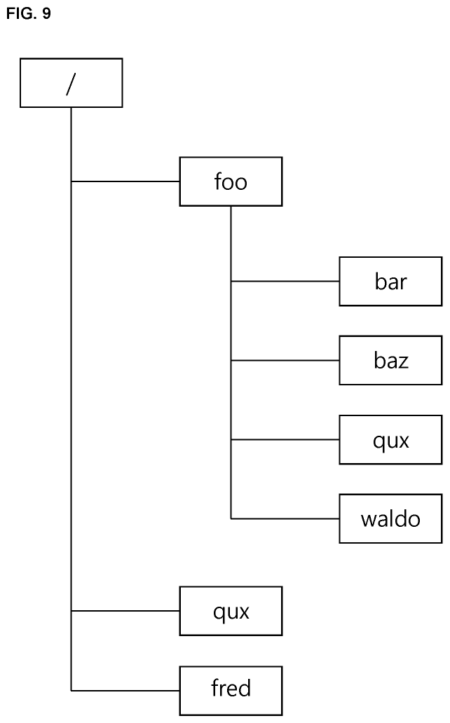

FIG. 8 is a reference diagram illustrating a directory structure of a container volume corresponding to the directory structure of the deployment image file system of FIG. 6, and FIG. 9 is an overlay in which the deployment image file system of FIG. 6 and FIG. 9 is a reference diagram illustrating a directory structure of an overlay-mounted container file system in which the deployment image file system of FIG. 6 and the container volume of FIG. 8 are merged.

The deployment image file system is read-only, and its directory structure is as shown in FIG. 6.

On the other hand, the container volume is a writable directory, and the detailed structure of the directory illustrated in FIG. 8 is as follows:

/foo: Merged with the/foo directory of the deployment image file system and overlay-mounted to the/foo directory of the container file system. Directories and files to be changed under/foo directory of the container file system are stored.

/foo/bar: configuration file, data file, or log file directory of the bar module. Generated by the container making modifications to/foo/bar of the container file system.

/foo/qux: configuration file, data file, or log file directory of the qux module. Generated by the container making modifications to/foo/qux of the container file system.

/foo/waldo: Configuration file, data file, or log file directory of the waldo module. Generated by the container making modifications to/foo/waldo of the container file system.

The detailed structure of the container file system, where the deployment image file system and the volume are merged and overlay-mounted, is as follows:

/foo: Application installation directory, Overlay-mounted by merging the/foo directory of the deployment image file system and the/foo directory of the volume.

/foo/bar: Configuration file, data file, and log file directory of the bar module

/foo/baz: Configuration file, data file, and log file directory of the baz module

/foo/qux: Configuration file, data file, and log file directory of the qux module

/foo/waldo: Configuration file, data file, or log file directory of the waldo module.

Newly generated and modified in the container.

/qux: Symbolic link referencing/foo/qux

/fred: Directory where the volume is to be mounted.

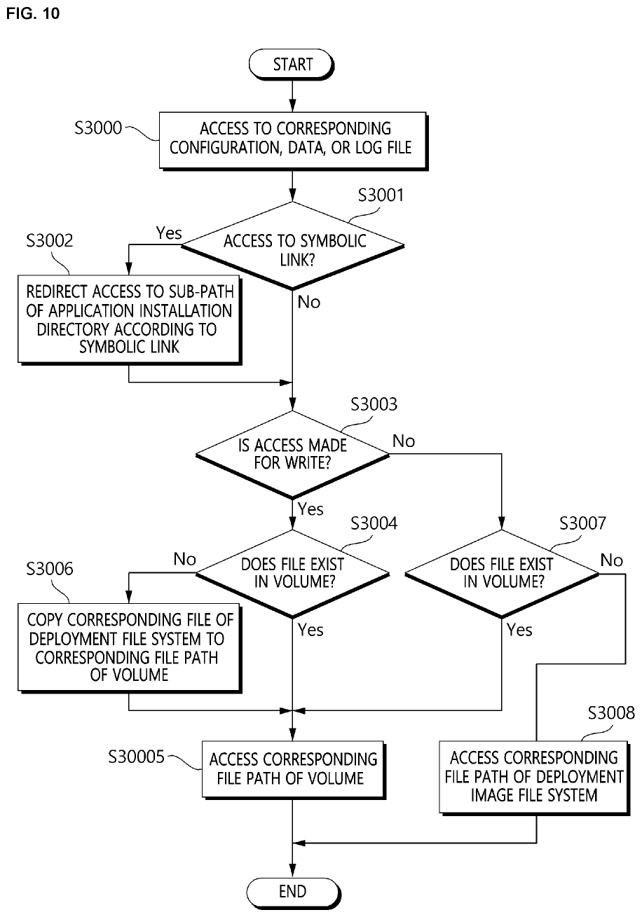

FIG. 10 is a flowchart illustrating a file access process for detailed modules of an application when a container-based information leakage prevention application is deployed and executed.

First, a detailed module of an application accesses its corresponding configuration file, data file, log file, or directory path (S3000). Next, it is determined whether the detailed module accesses a symbolic link corresponding to the default path, rather than a sub-path of an application installation directory, as it cannot set a path (S3001). If the detailed module accesses a symbolic link, the access is redirected to the configuration file, data file, log file, or directory path of the corresponding detailed module that moves to the sub-path of the application installation directory according to the symbolic link (S3002). Then, it is determined whether the access by the detailed module is for performing write mode (S3003). If the access by the detailed module is for performing write mode, it is checked whether the corresponding file or directory exists in a container volume (S3004). If the file or directory exists in the container volume, the detailed module accesses the file or directory in the container volume (S3005). On the other hand, if the file or directory is not found in the container volume, the detailed module copies the corresponding file or directory from the deployment image file system to the corresponding file or directory path in the container volume (S3006). Meanwhile, if the detailed module's access is not for performing write mode, it is determined whether the corresponding file or directory exists in the container volume (S3007). In this case, if the corresponding file or directory exists in the container volume, the detailed module accesses the corresponding file or directory path in the deployment image file system (S3008).

According to the present invention, an information leakage prevention application composed of a plurality of modules, each including a configuration file, a data file, and a log file, is allowed for efficient management of the configuration files, data files, and log files of multiple modules with a container volume, which is a single persistent storage, in a container environment,

The present invention may be implemented as a software program and be recorded in a certain computer-readable recording medium so as to be applied to a variety of reproduction devices. The variety of reproduction devices may be a personal computer (PC), a laptop PC, a mobile terminal, and the like. For example, the recording medium may be a hard disk, a flash memory, a random-accessible memory (RAM), a read-only memory (ROM), or the like as an embedded type in each reproduction device or an optical disc such as a compact disc recordable (CDR) and a compact disc rewritable, a compact flash card, smart media, a memory stick, or a multimedia card as an external medium.

Although the embodiments of the present disclosure have been described above, the embodiments disclosed in the specification are not intended to limit the present invention. The scope of the present disclosure should be interpreted through the following claims, and all equivalents thereof should be interpreted as being included within the scope of the present disclosure.

What is claimed is:

1. A method for building and deploying an information leakage prevention application based on a container, which is performed by a system for building and deploying an information leakage prevention application, the method comprising the steps of:
under a container environment, installing and configuring packages of an application for information leakage prevention under an application installation directory and building an image according to the creation of a deployment image for the application; and
deploying the application using the deployment image generated according to image building.

2. The method of claim 1, wherein the building of the image comprises:
creating a package image for the application;
installing and configuring at least one of configuration files, data files, or log files constituting the packages in a sub-path of an application installation directory; and
creating the deployment image for the application by committing changes in a container due to installation and configuration of the packages.

3. The method of claim 2, wherein the installing and configuring of the packages under the application installation directory comprises determining whether a detailed module is a path-settable detailed module that can set paths for the packages; and
if the detailed module is a path-settable detailed module, installing and configuring a configuration file, data file, or log file of the path-settable detailed module in a sub-path of the application installation directory.

4. The method of claim 3, wherein the installing and configuring of the packages under the application installation directory comprises,
if the detailed module is a path-non-settable detailed module that cannot set paths for the packages, installing and configuring a configuration file, data file, or log file of the path-non-settable detailed module in a default set path;
moving a configuration file, data file, or log file for the path-non-settable detailed module to a sub-path of the application installation directory; and
creating a symbolic link in the default set path to refer to the configuration file, data file, or log file for the path-non-settable detailed module.

5. The method of claim 1, wherein the deploying of the application comprises defining a container volume to be overlay-mounted to the application installation directory and deploying the application by executing a container.

6. The method of claim 5, wherein an application installation directory of a container file system according to the deployment of the application comprises a directory structure where an application installation directory of a deployment image file system, which is a read-only lower layer, and an application installation directory of a container volume, which is a writable upper layer, are merged.

7. The method of claim 6, wherein in the application installation directory of the container file system, when changes are made to configuration files, data files, and log files in a container, configuration files, data files, and log files of the application installation directory of the deployment image file system are copied to the application installation directory of the container volume, and configuration files, data files, and log files of the application installation directory of the container volume are modified.
